(19) United States
(12) Patent Application Publication
(10) Pub. No.: US 2003/0093352 A1
(43) Pub. Date: May 15, 2003

(54) Method, apparatus and program for evaluating financial trading strategies and portfolios

(76) Inventors: Sanjay P. Muralidhar, Ridgefield, CT (US); Arun S. Muralidhar, West Windsor, NJ (US)

Correspondence Address: Steven R. Bartholomew, Esq., Morgan, Lewis & Bockius, LLP, 43rd Floor, 101 Park Avenue, New York, NY, 10178, US

(21) Appl. No.: 10/271,056

(22) Filed: Oct. 14, 2002

Related U.S. Application Data
(60) Provisional application No. 60/328,957, filed on Oct. 15, 2001.

(51) Int. Cl. G06F 17/60

(52) U.S. Cl. 705/36

(57) ABSTRACT

A flexible tool for creating enhanced investment portfolios across any asset or combination of assets, by combining investment rules, based on investor-specific objectives. Many innovative approaches are presented to investors through a user-friendly, platform-neutral, interactive technology that guides them to formalize their analysis. The invention improves efficiency of the investment process by providing this flexibility under a robust platform thereby eliminating errors that could prove costly to the investors. It leverages the fact that many of the processes are repeated across different investment areas and therefore by providing a single platform across which all these decisions can be made, and allowing for aggregation of multiple decisions, the investor is able to compare and contrast investment recommendations across all parts of the investment decision process.

### RELATED CASES

This application is based on U.S. Provisional Patent Application Serial No. 60/328,957 filed on Oct. 15, 2001.

### FIELD OF THE INVENTION

This invention relates generally to computer-implemented business methods and financial instruments and, more particularly, to techniques for creating and managing enhanced investment portfolios, along with investment rules and strategies, to meet or exceed the individual objectives of a wide variety of investors.

### BACKGROUND ART

Present-day computerized investment analysis tools are deficient in many areas. These tools provide no mechanism whatsoever by which investors are able to flexibly test a wide range of trading rules across a plurality of asset classes, or across various levels of an individual security. Illustrative examples of assets include US Equities, US Bonds, International Equities, International Bonds, Emerging Market Equities, Commodities, and Currencies. Illustrative examples of indices that represent assets include indices such as the Merrill Lynch bond index, Standard and Poors 500 US Equity Index, and Standard and Poors Real Estate Index. Individual securities include company stocks such as Motorola and Lucent, as well as mutual funds and bonds of specific duration or even commodities and currencies such as Crude Oil, and the U.S. Dollar/Yen exchange rate.

Many prior art systems and methods are limited to a specific investment category. Consider the Baird reference, U.S. Pat. No. 5,220,500 (hereinafter referred to as “Baird”). The techniques disclosed in Baird are only applicable to stocks, and do not provide for the evaluation of trading rules to cover a broad set of investment alternatives available to investors. Moreover, Baird is not equipped to perform evaluations across all aspects of a portfolio (equities, bonds, commodities and currencies, as well as derivatives of these instruments). Another reference—the Melnikoff patent (U.S. Pat. No. 5,784,696)—only pertains to mutual funds.

Another shortcoming of prior art investment analysis tools is that they provide very limited ability in modifying data so as to create a derivative data set on which rules can be developed and evaluated. Consider Fenholz, U.S. Pat. No. 5,819,238, where the objective is to replicate the performance of an index using a set of selected assets. But Fernholz fails to address situations where the investor wishes to modify data to arrive at recommendations that might perform better than the index. A similar shortcoming is also evident in the Jones et al reference, U.S. Pat. No. 982,942 (hereinafter referred to as “Jones”).

Prior art techniques of investment data modification are generally limited to assets which are actually going to be traded. While some computer-based investment advisory and analytical methods may offer technical trading rule models, these are limited to a particular type of data (price of a security only) and limited to pre-specified rules (e.g., moving average trading rules, relative strength indicators, etc.). Further, technical trading rules compare the current price of a security or asset against historical performance or behavior of the same asset. The prior art set of tools that allow the testing and development of trading rules are limited to a particular type of technical evaluation of price data where the tools enable an evaluation of trading patterns of a certain asset and are based on pre-set technical indicators (moving averages, price charts, max and min levels, 52 week highs and lows, volatility, volume, etc.). These tools allow a trading action on the same asset and an evaluation of the profitability of that strategy. However, the investor may wish to apply these technical modifications on economic data (e.g., 5 month moving average of inflation) to trade a particular security. This is not envisioned or facilitated in prior art. In a similar vein, prior art does not help investors who are combining different types of data to evaluate a rule (for example, using economic data to evaluate a rule on the Merrill Lynch Bond Index or some series on the seasons of the year to trade US Equities). This shortcoming inconveniences the investor, who is called upon to perform a multiplicity of partial analyses in separate environments, and to devise a technique for combining these separate analyses into an integrated environment (e.g., through the use of EXCEL spreadsheets to aggregate rules tested using prior art methodologies).

Prior art computer-implemented investment analysis techniques only evaluate a single and specific rule (e.g., as described in Fernholz). Very often, this methodology requires significant prescience on the part of the investor who may, in fact, not possess the requisite background knowledge. Likewise, a substantially optimized rule may or may not provide results commensurate with a rule selected from a set of pre-specified rules.

In the prior art, where such tools exist, they rely on historical data. Historical data presents limitations, in the sense that this data represents only a single path out of the many thousands of paths that could have occurred. Hence, these prior art tools run the risk of providing a very incorrect perspective on the efficacy of a rule. Tests based on historical paths tend to provide strategies with a low probability of success in the future.

The prior art set of tools available to investors, within their limited scope discussed herein, also tend to pre-select the investment objective—normally absolute return and occasionally risk adjusted return (based on the vendor's definition of risk adjustment like Morningstar). Since different investors may have different objectives and methods of evaluating performance, the foregoing approach, employed by Melnikoff (U.S. Pat. No. 5,784,696) and Champion et al (U.S. Pat. No. 5,126,936) limits the applicability of these investment analysis and decision making tools to very special classes of investors.

The prior art does not consider the fact that the selection of an investment opportunity may be based in a currency other than that of the investor (e.g., a Dutch investor buying U.S. stocks must worry about the performance of the stock and the currency exchange rate at the time of buying and selling the security). Ignoring such nuances could lead to incorrect portfolio decisions for investors as the basic rule/strategy may be profitable or successful but when converted back into the investor's currency may not yield any or the same degree of success.

Prior art does not allow the user to combine or aggregate different trading rules or build strategies/rules for different classes of assets that comprise a portfolio and view the cumulative effect of all the strategies/rules on the overall portfolio, especially when the structure of such portfolios varies by investor.

Similar tools that exist in the prior art offer very limited imposition of constraints and typically these only operate at the level of the rule development (for example, limits can be set related to the size of the position in the asset traded, or on a leverage condition).

The prior art is designed to help investors make decisions on a daily basis, whereas some institutional investors may choose to make decisions only once a week or once a month. The frequency of decision making is intricately tied to the type of investor and prior art has catered largely to the financial trader, whereas others with an interest in investment strategies such as managers of pension funds, mutual funds or central bank portfolios may tend to trade or modify their portfolios less frequently. Currently, investors must conduct such evaluations individually and separate from any software that they may have acquired, using spreadsheet-type applications and this is time consuming and prone to error. A number of institutional investors need such simple analytical functions as they evaluate investment options, thereby increasing the efficiency, consistency and quality of their work.

Prior art largely focuses on static asset allocation decisions within a portfolio that merely identify an optimal portfolio structure (benchmark assets and allocations) at a single point in time. As a practical matter, this approach has severe limitations as it does not take into account changes in market conditions and investment risks/opportunities arising out of these changes. Thus, by focusing on a defined investment horizon and making a static portfolio allocation decision for that period, thereby ignoring market conditions in intermediate periods the prior art is limited in its ability to support investors on an ongoing basis.

### OBJECTS AND SUMMARY OF THE INVENTION

The invention address these and other shortcomings of the prior art by providing computer-based tools for creating and evaluating enhanced portfolios across any asset or combinations of assets, and for combining rules/strategies in complex ways, based on investor-specified objectives. A user-friendly, interactive methodology guides investors to formalize their analysis. In addition, the efficiency of the investment process is improved by providing accurate and consistent evaluations across a plurality of investment allocations and eliminating errors that could prove costly to the investors. By realizing that many analysis steps are repeated across different investment areas, it is possible to improve efficiency by providing a single platform across which a plurality of different investment decisions can be made. Moreover, by aggregating multiple investment decisions, the investor is able to compare and contrast investment recommendations across all aspects of the investment decision process.

Accordingly, one object of the present invention is to provide computer-executable methods that address one or more of the above-identified shortcomings of the prior art for evaluating investment strategies and managing investment portfolios.

Another object of the invention is to provide a computer-executable method for creating, evaluating, and monitoring investment rules/strategies over multiple or specified historical time periods, for any type of investor in any financial market or economic region across a broad range of investment instruments (including indices in any asset class, investment managers in any asset class, mutual funds in any asset class, currencies, commodities and securities in any asset class). Accordingly, individuals and institutions will be able to evaluate and develop investment/trading rules/strategies that, in turn, will allow them to construct investment portfolios that meet their respective investment objectives, so as to facilitate enhanced monitoring, reallocation and/or rebalancing of these portfolios in a dynamic fashion over time. The term dynamic relates to the fact that, throughout a relatively long-term investment horizon, it may be desirable to make adjustments or corrections from time to time. Decisions regarding the proportion of assets in which monies are invested can be changing and, therefore, the allocations will be changing. Unfortunately, many of the prior art tools force the investor to hold a fixed proportion of the assets (static allocations) over an investment horizon.

Still another object of the present invention is to facilitate user/investor/client access to an online, computer-based system.

A yet further object of the invention is to construct enhanced trading rules/strategies based on combinations of economic, financial (including but not necessarily limited to price data on the investment instrument(s)) and/or other data that might be developed by investors to drive investment decisions.

A still further object of the invention is to provide computer-based method(s), systems and/or article(s)-of-manufacture to store data required by users (investors) to meet their objectives of determining enhanced investment rules/strategies, to test these rules/strategies on selected historical periods, to monitor the performance on an ongoing basis, and to evaluate their performance in current and future markets, to simulate market conditions in the future with input by users to evaluate the performance of the rules/strategies under different scenarios and perform optimization techniques on certain rules/strategies to optimize certain performance characteristics. Such data, collectively termed signal data, will include, but is not limited to, economic (both macro and micro economic), financial (return, yield, pricing and statistical), specific portfolio related data of the user (investor), specific data developed by the user to evaluate and/or forecast the direction of financial markets and signal investment actions. In addition, the data will include complex mathematical and/or statistical modifications to the data set from the above mentioned data.

Another object of the invention is to provide a method/apparatus that allows the user to specify how they define success of the investment strategy (i.e. the investment objective) from a broad menu of options, specifically maximize return with an allowable level of risk, or maximize risk adjusted returns, or maximize absolute return regardless of risk and so on. The invention therefore, allows different investors to determine their own criteria for selection of successful investment rules/strategies and test/measure the performance of their rules/strategies and the resultant portfolios against these selected criteria. Furthermore, the current invention allows user/investors to change these criteria among different rules/strategies or asset classes within their portfolio so that there is maximum flexibility in the building of a portfolio (for example for a certain asset class (equities) the investor may want to maximize a certain type of risk adjusted performance and for another asset class (currencies) they may want to manage risk by setting a budgeted risk limit and for a third asset class (private equity) they may want maximum absolute returns). In addition, the current invention envisions a methodology to use multiple objectives is an assigned hierarchy or weighting to develop single scores/ratings/rankings so as to facilitate the choice between different strategies.

And an additional object of the invention is to provide the user with the ability to impose constraints (e.g., no leverage, a certain amount of risk, a specific risk-adjusted return, or limits on the size of certain assets within the portfolio) to construct specific rules/strategies and portfolios for the individual investment objectives.

These and other objects are realized, at least in part, by the present invention, the general aspects of which are outlined hereinafter. Generally speaking, and without intending to be limiting, one aspect of the present invention relates to a computer-based system for evaluating a broad range of trading and investment rules/strategies. Financial data from public sources as well as those provided by the user to the system that may be proprietary (historical as well as that required to perform simulations of the future) are stored on a computer-readable data storage drive. A processing mechanism, coupled to the data storage drive, is programmed to test and evaluate a plurality of investment/trading rules/strategies. A user interface mechanism is provided for linking the processing mechanism to at least one user terminal through a data communication link; and displaying, at the user terminal or remote terminal, information concerning the selection or development of investment strategies to test/evaluate and choice of the individual's investment objective, constraints, and time horizon.

Pursuant to a further embodiment of the present invention, an analysis mechanism is provided to explore a plurality of investment possibilities in the neighborhood of the rule being tested, using an iterative procedure to facilitate the investor finding an enhanced or substantially optimized rule (as investors may not have the prescience to pick the best rule on their own), as well as facilitating an understanding of how the performance of the rule/strategy changes with changes in certain variables or metrics (sensitivity analysis). This process allows investors to evaluate rules in a range of possible outcomes, thereby minimizing the chance that they did not select the best available rule. Further, the current invention is envisioned to include optimization tools that will allow the user/investor to optimize the rules they create to maximize a specified objective, given specified constraints.

Pursuant to another embodiment of the invention, the trading rules are evaluated against historical data to identify potential winning strategies. Simulations of the trading rules and variables are then performed into the future using techniques like Monte Carlo, stochaistics or other statistical forecasting methods. Historical data presents only one path of observations and hence any tool that allows clients to evaluate over multiple paths provides more robust estimates of the efficacy of the rule. In addition, these rules can be evaluated over any duration of a single historical period (1995-2000) or multiple non-overlapping periods (1990-1993, 1994-2000) or multiple overlapping periods (1990-1996, 1994-2000).

The aforementioned rules/strategies can be designed to meet any objective function, including but not limited to (i) highest absolute return; (ii) excess returns over naively investing in the benchmark; (iii) highest risk-adjusted return (where risk-adjustment can be defined in multiple ways); (iv) lowest turnover etc. In addition, the current invention envisions a methodology to use multiple objectives is an assigned hierarchy or weighting to develop single scores/ratings/rankings so as to facilitate the choice between different strategies.

Rules/strategies can be evaluated and the final determination of success can be expressed in any base currency of the investor. In the current invention, this adjustment for the definition of the base currency and the subsequent translation of all returns back to this currency will be dealt with accurately and appropriately.

Pursuant to a further embodiment of the invention, users are provided with a mechanism to test combinations of successful rules to obtain the best performing aggregate rule (referred to herein as a strategy). This is an important feature, because what appears to be a profitable rule/strategy may fail to add value over other rules/strategies, or alternatively may be a poor rule/strategy to combine with other rules/strategies. Hence, it is important to be able to evaluate rules and strategies in isolation as well as in conjunction with other rules and strategies. This functionality is further extended to the concept of a portfolio where an investor can develop rules/strategies to invest in various asset classes and all of them may satisfy their objectives within these narrowly defined asset classes, but since those asset are viewed as part of a portfolio, it is also critical that the investors are able to evaluate the combination of all these rules/strategies across all the asset classes it invests in to ensure that the aggregation still meets the investment objectives. This ability to roll up rules/strategies within the context of a portfolio provides for effective governance as it allows overseers of such assets a unique view of the impact of combining different parts of the organization into one consolidated value.

Pursuant to a further embodiment of the present invention, a constraint imposition mechanism is provided for the imposition of several constraints typically applicable in portfolio construction (e.g. risk limit, leverage, maximum holdings of any asset/asset class, stop loss levels, re-entry rules, etc.). Further, these constraints can be layered and super-imposed so that some of them are effective at the rule level and others operate at a strategy level.

Pursuant to a further embodiment of the present invention, a monitoring mechanism is provided to allow continuous monitoring and reporting on the performance of rules/strategies whenever the underlying data is updated.

Pursuant to a further embodiment of the present invention, a recommendation tailoring mechanism is provided that allows the user to tailor the investment recommendation to the periodicity and for time horizons (i.e. profitable over a 1-year horizon) that is most appropriate for that investor. Notwithstanding this periodicity, the monitoring of these rules/strategies and the resultant portfolios will take place as described above.

Pursuant to a further embodiment of the present invention, a data analysis mechanism is provided to analyze data on the performance of any asset, investment managers, mutual funds etc. The current invention allows this data to be treated as an input to the system, which can then allow investors to evaluate such investment options and moreover perform this evaluation as part of a rule/strategy or as one of the alternative investment within the portfolio, thereby expanding the value of such a system to an investor.

Another benefit of this invention is that it can be developed for investors regardless of physical location—i.e., is a product where service and functionality can be delivered through web-centric technology. The functionality is supported by an extensive database, which is envisioned to be a combination of both public data (i.e., published by government authorities or any other publisher of such data) and, possibly, private data (e.g., manager performance data is unique for institutional investors or a series created by the investor to capture seasonality in markets) and can be hosted either by the client (user) or by a vendor (inventor) or a combination of both. In addition, investors can create complex variations of public or private data and store this data as well either to create new assets or to be used as a condition for determining whether to buy an asset or to establish how much to buy/sell and when. Further, security features built into the current invention will ensure that the trading rules/strategies that each investor (user) develops is entirely a function of their own efforts and these rules/strategies will remain proprietary to that specific user.

### BRIEF DESCRIPTION OF THE DRAWINGS

Certain aspects of the present invention are depicted in the accompanying drawings, which are intended to be considered in conjunction with the detailed description below, and which are intended to be illustrative rather than limiting, and, in which:

FIG. 1 is a chart that illustrates the overall architecture of the invention, emphasizing that access to the computer system and its entire functionality is available remotely whether through the internet, telephone lines, wireless access or future technology that enables remote access;

FIG. 2 is a chart that displays the various modules envisioned in the current invention and their interactions with each other and users;

FIG. 3 illustrates the process that a user would follow in the use of the system;

FIG. 4 illustrates the various steps involved in the data analysis and modification functionality;

FIG. 5 illustrates the various steps involved in the creation of rules as envisioned in the current invention;

FIG. 6 illustratively depicts the structure of a portfolio that an investor would manage and the decision nodes at which rules/strategies developed in the current invention would be applied for decision making within the context of portfolio management;

FIG. 7 illustratively depicts the construct of a rule that can be developed and tested by the current invention and displays some typical considerations in defining such rules in accordance with the present invention and further depicts how rules make up strategies;

### DETAILED DESCRIPTION OF THE INVENTION

By way of introduction, the following definitions are employed herein:

“Storing” may include writing said information into a random access memory, writing said information into a magnetic storage device, and/or writing said information into an optical storage device, and may also include storing information within the structure of an extensive database, which is envisioned to be a combination of both public data (i.e., published by government authorities or any other publisher of such data) and, possibly, private data (e.g., manager performance data is unique for institutional investors) as also economic, financial or proprietary data developed by users for use in predicting general or specific financial market performance and includes any mathematical and/or statistical modifications on the basic data that the users may choose to perform so as to improve the predictive capability of the data and use it as signal data as defined herein.

The data communication link preferably includes at least one internet segment, and the linking process preferably includes authenticating the user terminal as an authorized user.

“Displaying” preferably involves use of an internet browser, and includes displaying information that would show the user the unique structure of their portfolio including the allocation to different classes, the rules/strategies used within each of these asset classes, portfolios and the rules/strategies that compose the portfolio within each of the asset classes, the constraints imposed on the portfolio as a whole or any part thereof (eg. leverage, size of an individual asset, risk limit, trading quantity, etc.); the entire data set available to the user and the various modifications that can be made to this data to enhance it's predictive capability; the ability to create rules/strategies at each level in the portfolio and the ability to consolidate the various rules into a strategy to enable decision making at the consolidated level as well as at an asset level within the portfolio. “Displaying” further includes notification sent to customers monitoring their portfolio and the ongoing status of their active rules/strategies as data is updated through available communication mechanisms (like a live trade blotter or a listing of trade recommendations accessible through their account on the internet, phone, email, etc.)

The term “investor” encompasses individuals investing their own funds, institutions that manage money for an organization (e.g., pension funds, central banks, insurance companies, endowments), as well as multiple organizations and individuals (e.g. mutual funds, asset management companies). Investors make decisions in the market through brokers or, alternatively, may delegate certain responsibilities to investment managers. The term “investor”, as employed herein, is intended to represent all types of investors, whether individuals or institutions. The term “investment manager” is used to generically represent all companies that offer their investment services to investors through investment products, including mutual fund companies, investment management companies for institutional investors, and the like.

The term “signal data” is used to describe any data that an investor (user) uses as an input to determine investment actions (trades) taken within a rule or strategy as defined herein. Such data will include, but is not limited to, economic (both macro and micro economic), financial (return, yield, pricing and statistical), specific portfolio related data of the user (investor), specific data developed by the user to evaluate and/or forecast the direction of financial markets and signal investment actions as well as mathematical and/or statistical modifications to the above mentioned data.

The terms “rules”, “investment rules”, or “trading rules” signify any user-defined criteria for determining trading quantities between two assets that represent a benchmark. This trading can apply at any level in an investment portfolio (illustratively, subject to a two asset limitation), and can be based on a single criterion or multiple criteria (each of which may be composed of multiple embedded conditions) applied to the signal criteria (Example, IF signal data>A, buy x% of Asset1, ELSE sell x% of Asset1). However, a single trade recommendation is produced for each period, which may have certain constraints imposed on it (including, but not limited, to stop loss, upper and lower level asset positions, trade size, re-entry conditions, shorting and leverage, etc.).

The term “strategy” or “investment strategy” signifies a combination of one or more rules (possibly with variable weights assigned to each rule) that can be applied at any level in an investment portfolio, without the two-asset limitation for rules, but with similar constraints. A strategy allows trading between more that two assets, can have a benchmark with multiple (i.e. more than two) assets, can trade assets not in the benchmark, and the benchmark allocation relevant to a strategy can be different from the benchmarks for the underlying rules. From the foregoing, it is clear that a rule is a stylized case of a strategy, with a strategy allowing for a much greater flexibility in the portfolio structure and the associated strategy development.

A “portfolio” refers to a collection of investments held by an investor and managed as one cohesive group of investments. The structure of a portfolio normally tiers down from the total portfolio to asset classes (equity, fixed income, commodities, real estate, etc.), to geographic markets (US, International, Emerging Markets, etc.), to sectors (Large Cap/Small Cap, corporate/government/junk, etc.), to style (Value/Growth/Momentum, etc.) to managers/securities. The order of these tiers is not important as this structure can be adjusted so that style may be decided before markets, and so on.

Investors typically make decisions on managing their portfolios relative to a benchmark or a combination of multiple benchmark assets. The benchmark(s) may be explicit or implicit, but, in either case, it specifies a target allocation for each asset class (e.g., US equities, Non-US small capitalization equities, US high yield bonds, Real Estate Investments), the underlying index to which asset performance will be measured (e.g., S&P500 Index for US equities), and the maximum permissible deviation from a target weight. In the absence of any such specification, it is normally assumed that the investor seeks the best absolute return and is measuring himself/herself against a zero return. Hence, zero return can also be seen as a benchmark.

Once the portfolio structure is defined, investors will make a decision whether to follow an active or passive investment strategy. In a passive investment strategy, investors make investments in benchmark(s) in the predefined allocation percentages and let these investments remain in place for the duration of the investment period, with the only intervention being a periodic rebalancing of the portfolio to conform to the allocation guidelines, or to reflect periodic reviews of the portfolio allocations to the various asset classes and changes to the same. The Fernholz reference caters to this limited action. If investors decide to pursue an active investment strategy with the objective of outperforming the benchmark(s), investors will need to make decisions as to whether they manage their investments themselves or outsource the function to investment managers. In order to outperform the benchmark, the investor can engage in some or all of the following activities: (i) deviate away from the target (benchmark) weights in the various asset classes; (ii) hire investment managers who can outperform these asset class benchmarks through selection of individual securities that may or may not be included in the benchmark; (iii) compose the portfolio so that managers are given an index benchmark that is different from that of the asset class benchmark (e.g., while the asset class benchmark may be S&P500, the investment manager may be told to manage the funds relative to the Wilshire 5000 or a manager may be selected whose style closely tracks the latter benchmark); and (iv) choose securities that are different from those of any of the asset class or manager benchmarks and in weights that are different from those in the respective benchmarks. Most of these decisions made by investors are based on a belief or conviction that these changes will allow them to outperform their benchmark by favoring winners against losers. In order to make these decisions, investors need a set of investment analysis tools that allow them to (i) evaluate the various alternatives that are available to them and; (ii) decide if and when each or any of these alternatives should be activated in order to maximize their returns.

Essentially, investors need to formulate formal rules/strategies to make such deviations from benchmarks in order to prevent improper or ad hoc management of assets (i.e., within the construct of good oversight and governance) and facilitate maximization of returns given certain constraints. The substance or logic of the rule(s) may appear arbitrary (e.g., a rule whereby the investor buys an asset every January and sells every December) or may be based on some economic data (e.g., a rule whereby the investor buys an asset every time inflation rises and sells every time inflation falls, in each case, possibly further defining ranges) or may be based on financial data (e.g., a rule whereby the investor buys an asset every time the price of the asset rises five days in a row) or may be based on other, seemingly unrelated, data (e.g., buy assets based on number of sunspots in any given month). However, once the rule is proposed and before it is formalized, regardless of the economic relationship between the asset and the underlying data or the apparent lack of such relationship, the investor needs to see whether this rule would have succeeded over one or more (both overlapping an non-overlapping) historical periods as well as gain an understanding of how well it has worked, what its limitations are and when the rule is effective and when it is ineffective in meeting a broad range of or a selected few investment objectives.

The invention relates to computer-implemented techniques for evaluating a broad range of trading and investment strategies, across a broad range of investment instruments (including indices in all asset classes, investment managers in all asset classes, mutual funds in all asset classes, currencies, commodities and securities in all asset classes) over multiple or specified historical time periods, for any type of investor, in any financial market or economic region (i.e. base currency). Another aspect of the invention facilitates construction of optimal trading rules/strategies based on signal data, which can be economic, financial (including but not necessarily limited to price data on the investment instrument(s)) and/or other data developed by investors to drive investment decisions. A still further aspect of the invention simplifies determination of optimal rules/strategies by using iterative tools as well as optimization techniques to find the rules/strategies that best meet investment objectives and/or a set of constraints.

Further aspects of the invention allow investors to flexibly test a wide range of trading rules across all asset classes. The functionality for such evaluation is provided across equities, bonds, commodities and currencies both at an aggregate level (e.g., S&P500 index, Merrill Lynch bond index, Oil, USD/Yen exchange rate) as well as at the level of an individual security (e.g., Lucent, a mutual fund or a particular duration bond). The current invention allows the investor to analyze one or many data series to use as signal data,—including fundamental economic data, financial data (including but not necessarily limited to price data on the investment instruments), other data that might be developed by investors to drive investment decisions, technical variations of fundamental data (i.e., compare today's price inflation data to the previous 3-month average), and mathematical and/or statistical modifications on any of the above data series. Also, the user can trade any asset regardless of the underlying signal data series being used to drive the rule. For example, if one believes that the decision on whether the U.S. stock market will outperform the Japanese stock market is determined by the differences in economic growth rates, then the investor would like to create such a data series (from elements which are publicly available) and test the rule.

A still further aspect of the invention allows a user to specify how they define success of the investment rule/strategy (i.e. the investment objective) from a broad menu of options, such as a maximization of return with an allowable level of risk, a maximization of risk-adjusted returns (using a number of risk-adjusted performance measures), a maximization of absolute return regardless of risk, a maximization of return relative to a benchmark on an absolute or risk-adjusted basis, a minimization of underperformance relative to a specified benchmark or relative to a number of consecutive negative months, and so on. A related aspect of the invention allows a user to use multiple objectives is an assigned hierarchy or weighting to develop single scores/ratings/rankings so as to facilitate the choice between different strategies. Another aspect of the invention allows the user to develop and select rules/strategies that have been tested on historic data, and to continue evaluation of these rules/strategies on a real time basis, and/or on simulated future scenarios. Using the techniques disclosed herein, individuals and institutions will be able to evaluate and develop investment rules/strategies that, in turn, will allow them to construct investment portfolios that meet their respective investment objectives and allow for enhanced monitoring and re-balancing of these portfolios in a dynamic fashion over time. As a result, a further aspect of the invention allows the user to combine and aggregate different rules/strategies within a portfolio to evaluate the performance of this portfolio relative to their investment objective. It also provides the user with the ability to impose constraints (e.g., no leverage, a certain amount of risk, a specific risk-adjusted return) to construct specific rules/strategies and resultant portfolios for the individual investment objectives. Finally, another aspect of the invention allows for the access of the functionality and tools discussed herein from remote locations (including through the internet or similar channels) with little or no systems or programming effort for the user, because such infrastructure is developed and maintained centrally.

Other aspect(s) of the invention relate to receiving a command, over said communication link, from a user of said user terminal, which may include a command to access certain data from the database and possibly perform certain modifications to such data, a command to create trading/investment rule/strategies and define the period over which such rule/strategy will be tested, whether historical or simulated future, or both, including any constraints that may be imposed upon such a rule/strategy and reports that may be required to evaluate the rule/strategy, a command to include the rule selected in a strategy and assign any rules/strategies to a particular section of a portfolio subject to any constraints that may be imposed upon such a portfolio and reports that may be required to evaluate the rule/strategy, and/or a command to define the structure of the portfolio, choose the investment objective(s), define any portfolio level constraints, benchmarks and allocations.

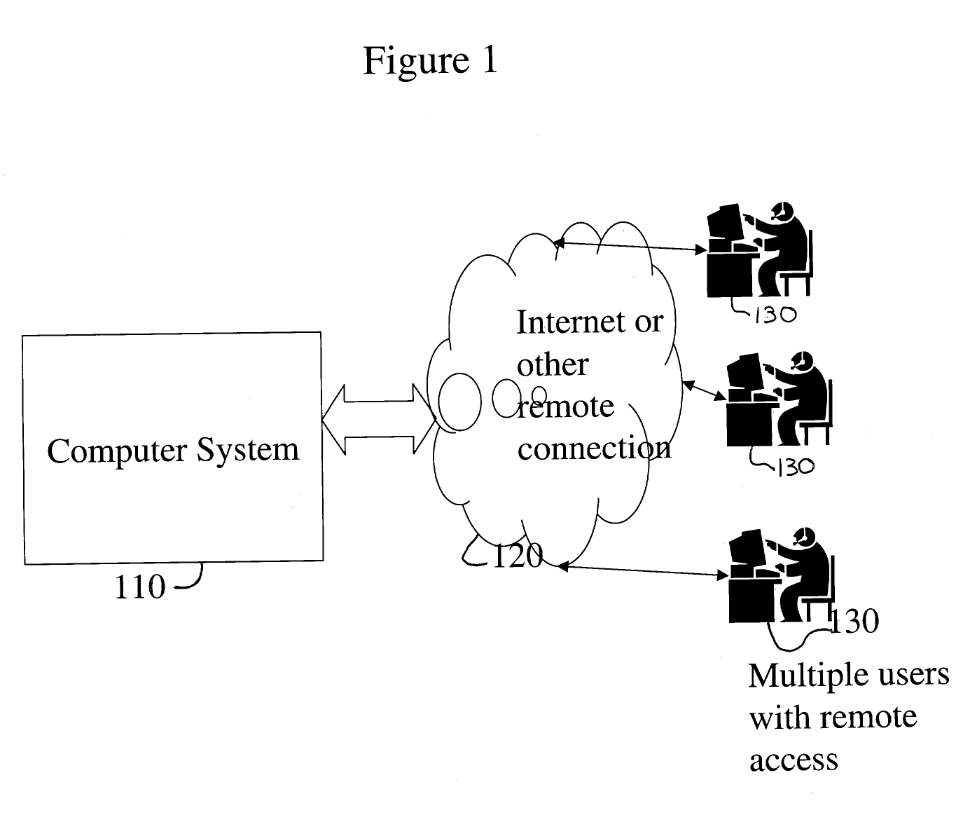

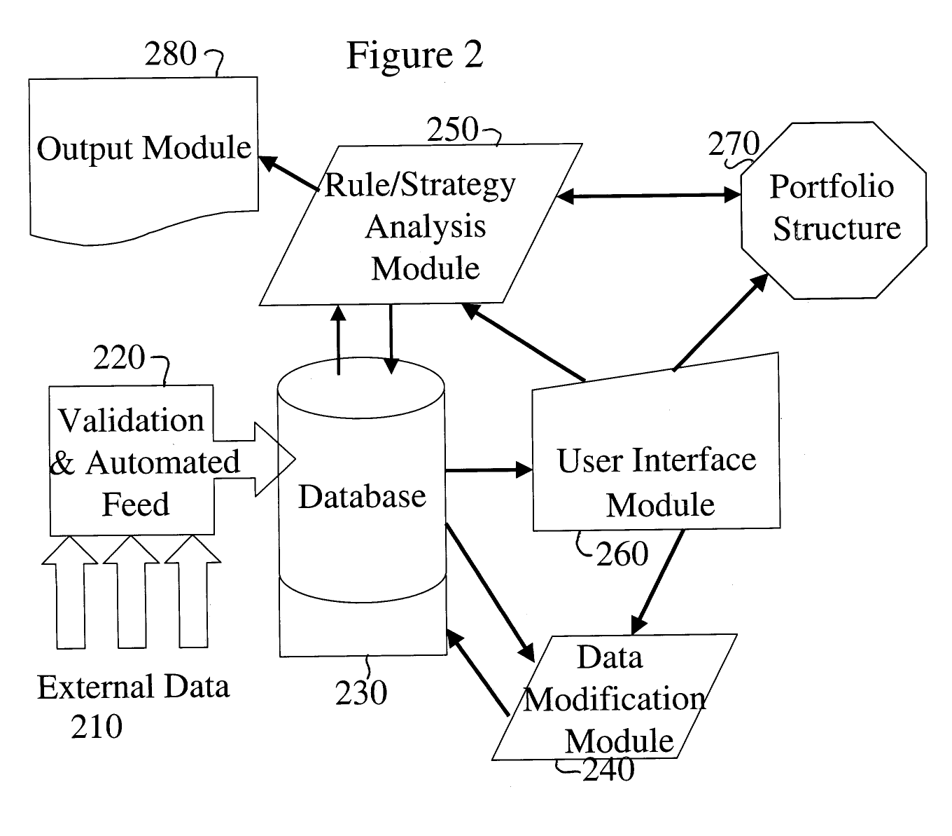

Referring now to FIG. 1, illustrating the various participants and their interaction envisioned in the present invention, the computer system 110 preferably includes all the modules further described in FIG. 2 including the database of financial information to be used. Customers 130 who will be using the invention may access computer system 110, via a communication link (of any sort, including, but not limited to, internet telephone, cable, wireless, optical, etc.), depicted as the cloud 120. Therefore, this invention would allow simultaneous access to multiple users, using the necessary infrastructure (internet or otherwise) to facilitate the acceptance of instructions from users and perform the necessary computations and feed the output from such computations back to the specific user. It is envisioned that much of this information will be generated immediately and fed back to users. However, in case some of the necessary computation requires a longer period of time, such tasks may be batched and run offline and the results fed back to users when such computations are complete.

Referring to FIG. 2, which illustrates the various modules envisioned in the current invention and their interactions with each other and end users. Here, data will be received from one or many external data sources (not excluding the possibility that the Customer will provide the data), 210, that include the historical price, return or yield data for the various assets as well as economic or signal data for comparable periods and such other data as may be required by users of the system. This data will then be processed through certain computer coded automated processes and validation checks, 220, to ensure the accuracy and integrity of the data and then will be stored in a database, 230, that will be accessed by the various modules of the system. The data can be in the form of either direct data, which is data received from an external data vendor and stored in the database, or complex data, which includes all data created by performing mathematical and/or statistical modifications to direct data such as changing by factors, or exponential adjustment, or even combinations of individual data series with algebraic weightings.

Such data will be defined and created using the data modification module(240) that is accessed through the user interface (260) that allows the user to modify the direct data to create new complex data series that can then be stored back in the database (230). Such complex data can be created in a number of different ways, including using one series of direct data or alternatively using multiple data variables.

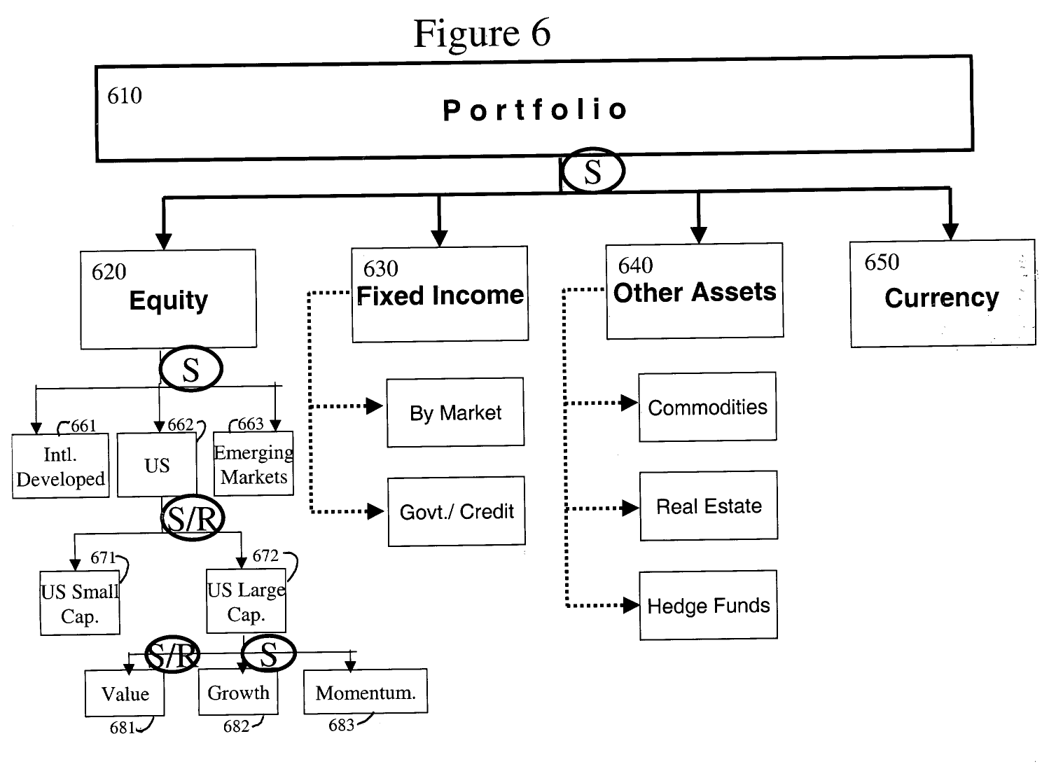

Users will access the computer system via the user interface, 260, and this will allow them to specify trading rules/strategies that they would like to test. The structure and description of these strategies/rules is further discussed in the description related to FIG. 6. The user interface (260) accesses the database (230) to define the specific rules/strategies to be tested, including any constraints to be imposed and these inputs are fed into the rule/strategy analysis module (250). The user interface (260) also helps the user to specify the structure of their portfolio (270) including all the assets and their allocations in the various benchmarks. In the analysis module (250), the profit and loss (P&L) of the various rules is calculated as are the P&L of the benchmark strategy and the difference of the two. This module also converts these values into return streams and index values for use in the analysis of a strategy. This module performs these calculations by accessing the historical data series in the database (230), will test the various strategies over the specified period and produce output results (280) that report on the results of the rules tested and whether these rules produced a return in excess of the benchmark, the associated risk of the trading strategy and similar information to evaluate whether the rule produces a trading strategy that might be used by the user. The output module (280), displays will be in the form of graphs (where the underlying variable can also be plotted against return charts) and tables. The output module (280) will allow the user to determine what output they would like to have displayed from a menu of many different possibilities. Finally, the user interface module (260) will give the user the ability to save specific rules that have been tested with a name or modify and re-run, and further apply the saved rules/strategies to specific decision nodes as specified in the portfolio structure (270) by the user as part of the input to the system to allow the necessary evaluation to be performed within the context of the investors portfolio.

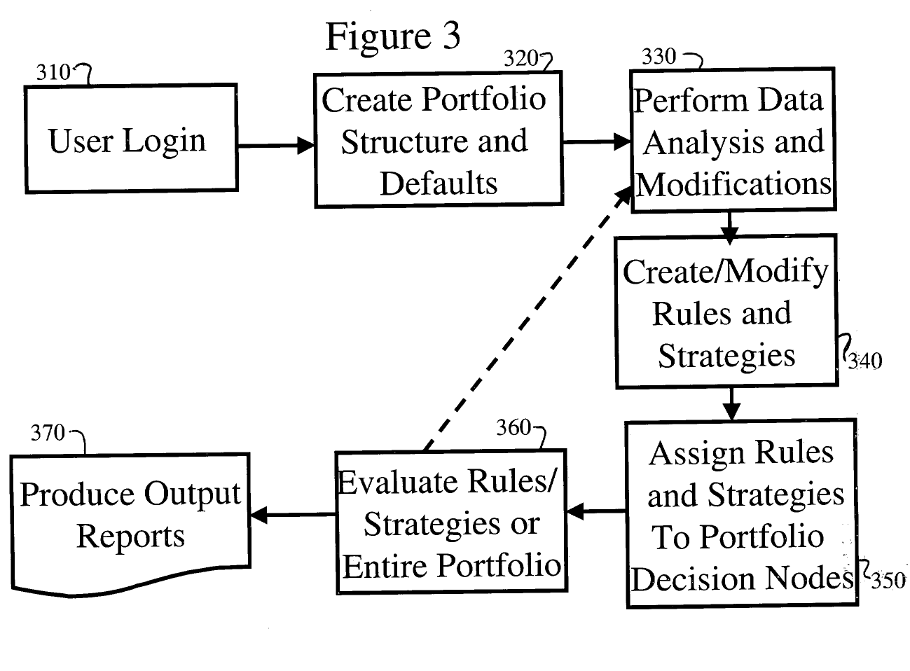

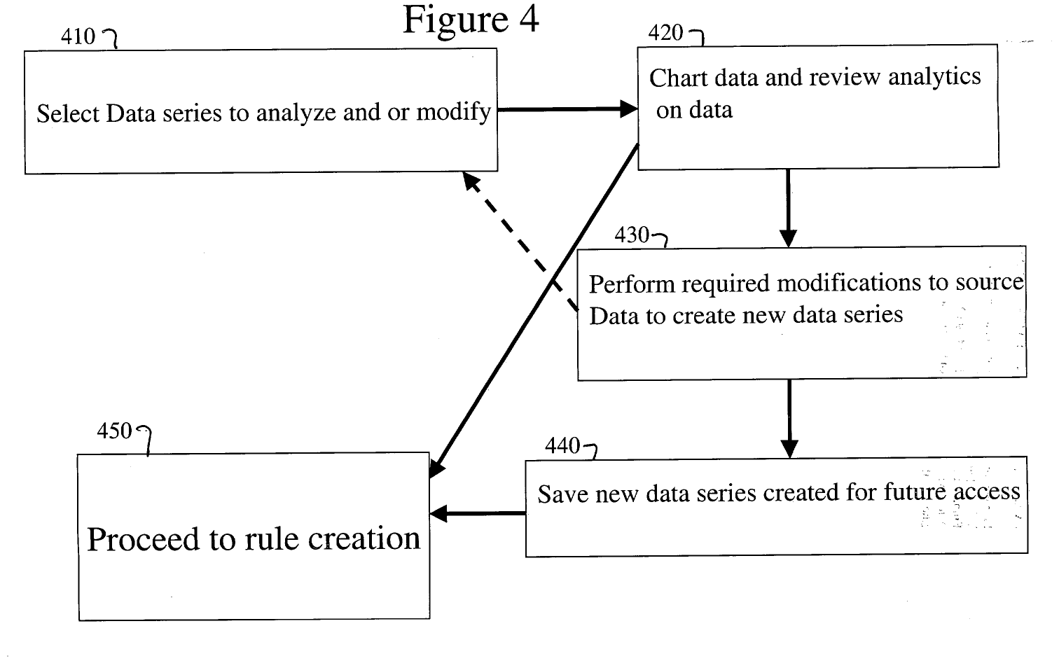

Referring to FIG. 3, which illustrates the process that a user would follow in the use of the system, the user would first login to the system (310) using a password and associated security features. Initially, the user would be required to input the structure of their portfolio and set up defaults that can be used in all the operations within the system (like base currency, asset allocation limits, rebalancing policy, leverage/shorting policy, etc.). The portfolio structure is discussed in further detail in FIG. 6 below. Next the user will proceed to performing data analysis and modifications (330) to determine and develop hypotheses for investment rules/strategies to be tested and/or create or refine signal data. These functions are discussed in greater detail under FIG. 4 below. Once the data is available for the development of rules/strategies, the user is ready to create rules and strategies (340). Normally, the user would create the rules first and then decide how to combine or aggregate them under strategies based on their evaluated success. Next the user will identify these rules/strategies to the various decision points or nodes in the portfolio construction decision process (350) so that the rules/strategies can be evaluated individually as well as within the context of a portfolio. This allows the aggregation of performance to be done appropriately and also facilitates performance attribution analysis of the portfolio. At this point the user may go back to the data analysis step (330) to redo some of the rules or create some new rules/strategies and continue this process iteratively. Finally, the user can produce reports (370) that analyze and calculate the various metrics required to fully understand the efficacy of the rules/strategies and the overall portfolio performance.

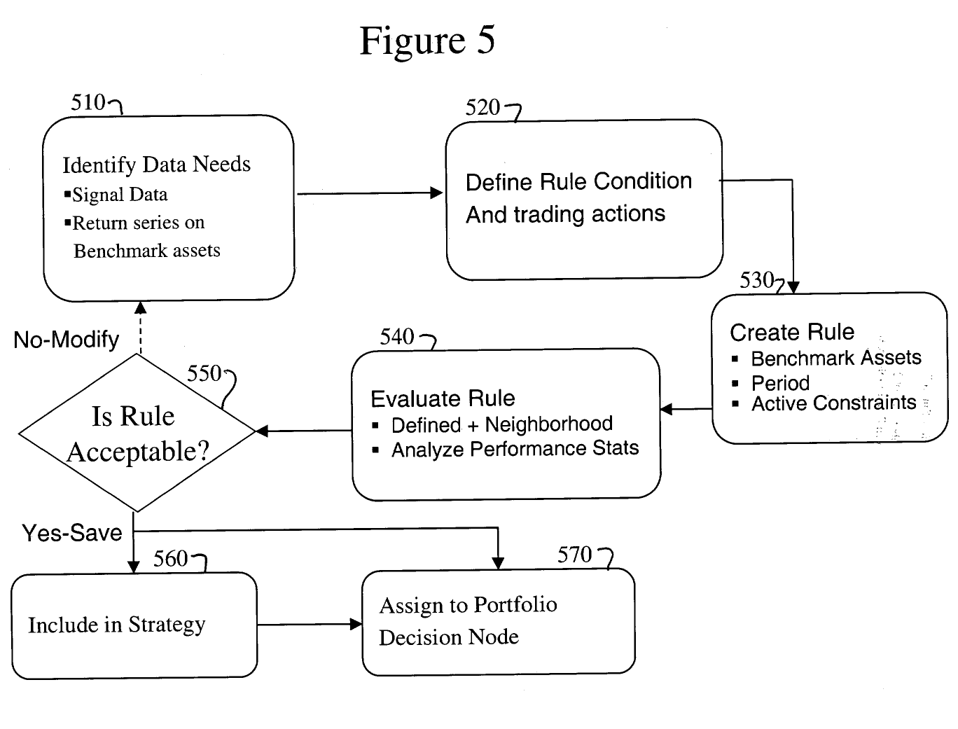

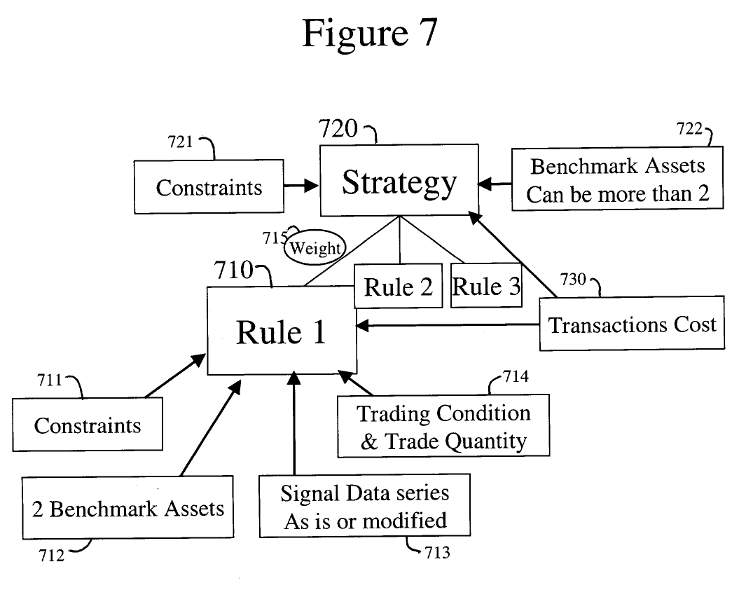

Referring to FIG. 4, which illustrates the various steps involved in the data analysis and modification functionality, the user would first select one or multiple data series that is/are to be analyzed or modified (410). The selected series can then be charted and various analytics displayed on the chosen series (420), both individually and relative to each other. For example, the charting function would include different variations of charting functionality that allow for the examination of any relationship between series that can be used in a rule as a trading condition, including Index Charts, Raw Data (on multiple axes), Histogram, Bar Charts, Interactive chart of partitions of data and analytics would include statistics like Maximum value, Minimum value, Mean, Range, Standard Deviation, Skewness/Kurtosis, Correlation, Simple Regression, Multifactor regression. At this point, if the user is satisfied that they can use certain data series without modification they can proceed to rule creation (450), alternatively they would proceed to performing modifications to source data (430). Here, the user can use the system to convert data in a number of ways to help development of signal data or in the construction of trading conditions and rules. These modifications include the following variations—a single function or multiple functions performed on a single series and a single function or various/multiple functions performed on multiple series and aggregated in some way. Most of these modifications/functions are quite familiar to those well versed in the art, but would include Statistical functions (mean, max/min, range (fixed/moving period), Standard deviation, Skewness/kurtosis, Z score, normal distribution, etc.), Technical functions (Moving Average, Exponential Moving Average, First Difference, percentage Change, percentage Change in 1^{st} difference, etc.), Time related functions (Lead, Lag, Spline (Linear/nonlinear), Step up/down in frequency, etc.), Arithmetic functions (Addition, Subtraction, Multiplication, Division, etc. (all using multiple series or a constant)), and Range Transformations, where a data series can be converted into decile, quartile and similar distributions for both Numeric and Alphanumeric data. Once these modifications have been completed, the user can save the resultant data series for ongoing future access (440) and then will proceed to rule creation (450), discussed below in FIG. 5. Referring to FIG. 5, which illustrates various steps involved in the creation of rules as envisioned in the current invention. The first step in the creation of a rule is to have an investment or trading hypothesis that needs to be tested and to further identify the data needs for testing this rule (510). The data series required are the returns on the benchmark assets (the assets being invested in) and the signal data (one or more) that will be used for the Rule condition. The next step is to define the rule condition (520) which essentially establishes the conditions under which various trades (Buy/sell/hold) of the selected assets will take place, and further defines how much of the assets will be traded. The trade quantity can be fixed for the entire strategy (a fixed percentage or a dollar amount traded every time the trading criteria is satisfied), variable (varies based on the level or changes in the signal data series) or some other scalar. In addition to the condition, to create the rule (530) the user will also be required to select the benchmark assets and their allocations, choose a period over which to test the rule and specify the constraints to be imposed upon the rule execution. These are discussed in further detail under FIG. 7. The next step would be to evaluate the rule (540) and examine whether it meets the investment objective. The current invention will also evaluate other investment possibilities in the neighborhood of the rule being tested using an iterative procedure to facilitate the investor finding the optimal rule (as investors may not have the prescience to pick the perfect rule on their own). This process allows investors to evaluate rules in a range of possible outcomes thereby minimizing the chance that they did not select the optimal rule as well as facilitating an understanding of how the performance of the rule/strategy changes with changes in certain variables or metrics (sensitivity analysis). Further, the current invention is envisioned to include optimization tools that will allow the user/investor to optimize the rules they create to maximize a chosen objective, given chosen constraints. If the rule is acceptable (550) the user can include it in a strategy (560, discussed in FIG. 7) and/or assign it to a Portfolio Decision Node (570, discussed in FIG. 6). If the rule is not acceptable, the user can loop back to box 510 and iteratively refine the rule to arrive at an optimal solution.

Referring to FIG. 6 illustratively depicting the construct of a portfolio as essentially being the aggregation of various investments. This is best viewed as a structure for aggregating the various investments contained in the portfolio as well as an identification of the various decision nodes where investors make investment decisions regarding the allocation of their available investable funds between two or more asset alternatives. Also, please note that this portfolio structure is merely illustrative and shows one structure to facilitate explanation, but the concepts discussed herein apply to a portfolio regardless of its structure or the assets invested in or the hierarchy of these asset classifications. The total portfolio (610) is invested in Equity (620), Fixed Income (630), Other Assets (640), and Currency (650), so here a strategy would be required to manage the allocation between the asset classes. We will look at the Equity investments in greater detail, but similar structures can exist under the other asset classes. The Equity investments may be further classified as International Developed Economies (661),US Equity (662) and Emerging Markets (663) and another strategy would manage the allocation of Equity assets to each of the three classes. Within US Equities (662), we may categorize the investments as Small Capitalization (671) or Large Capitalization (672) and this allocation between the two can be determined by a strategy or a rule (because there are only two benchmark assets). Finally, US Large Capitalization (672) can be broken down into Value Investments (681), Growth Investments (682) or Momentum Investments (683). The allocation to these three sub portfolios can be determined by a strategy, or alternatively a rule or strategy can be used to manage the allocation between Value and Growth with Momentum investments staying fixed in its weight.

Referring to FIG. 7, which illustratively depicts the construct of a rule that can be developed and tested by the current invention and displays some typical considerations in defining such rules in accordance with the present invention and further depicts how rules make up strategies. Each rule (710) would require a number of inputs, namely (a) the two benchmark assets (712) which indicates the investment asset that would be traded against a default alternative asset, (the performance of this strategy would be compared to a default benchmark strategy); (b) choice of constraints (including but not limited to stop loss, upper and lower level asset positions, trade size, re-entry conditions, shorting and leverage, etc.) that are imposed in a rule (711); (c) the signal series (713) as discussed in FIG. 4 and FIG. 5 and (d) the definition of the trading condition and the trade quantity (714) including whether the quantity traded is fixed, variable or some other scalar. Alternatively, the trading can be performed to reach certain targeted asset allocation levels from a starting asset allocation level. One or more rules can be aggregated into a strategy and in the case of more than one rules, each rule (710) would have a coefficient which would weight its contribution to the strategy (715). The investor would be able to impose constraints (721) on the aggregate strategy trade recommendations and also specify benchmark assets (722) for the strategy that can be more than two assets and also can be different from the benchmark assets selected in the underlying rules. Further, any assumptions for transactions costs or fees (730) that would be incurred to buy or sell a particular security would be input by the user and reflected in the performance calculations of all rules and strategies.

The above described arrangement is largely illustrative of the principles, workings and functionality of the current invention. The advantages of the system described above are not necessary all inclusive and other advantages, modifications and adaptations of the invention will be readily apparent to those skilled in the art.

What is claimed is:

1. A computer-based system for evaluating one or more investment rules, the system including:
(a) a computer-readable data storage drive for storing financial data associating each of a plurality of asset identifiers with a corresponding asset category; the financial data including historical data specifying past performance for each of a plurality of assets;
(b) a processing mechanism, coupled to the data storage drive, for evaluating a plurality of investment rules to generate an investment rule evaluation, each investment rule specifying at least one of: (i) a combination of asset identifiers, (ii) a combination of asset categories, (iii) a combination of asset identifier weighing factors specifying a relative proportion of a first asset to a second asset, and (iv) a combination of asset category weighing factors specifying a relative proportion of a first asset category to a second asset category; and
(c) a user interface mechanism, coupled to the processing mechanism, for linking the processing mechanism to at least one user terminal through a data communication link; and for displaying, at the user terminal, information related to the investment rule evaluation generated by the processing mechanism.

2. The system of claim 1 wherein the user interface mechanism is equipped to accept a user's selection of at least one investment rule, and wherein the processing mechanism responds to the selected investment rule by including an evaluation of the selected investment rule in the generated investment rule evaluation.

3. The system of claim 2 wherein the user interface mechanism is equipped to accept a user's selection of at least one of: (i) an investment objective, (ii) an investment constraint, (iii) a time horizon specifying a time duration for which the processing mechanism evaluates the investment rule, (iii) signal data indicative of a trading condition, and (iv) rule criteria that specifies a trading action (quantity/frequency) based upon the signal data.

4. The system of claim 3 wherein the processing mechanism further comprises an analysis mechanism for analyzing a plurality of investment possibilities at least roughly approximating the investment rule being evaluated, using an iterative procedure to facilitate an identification of an enhanced or substantially optimized rule, thereby permitting an investor to evaluate investment rules in a range of possible outcomes, and thereby minimizing the chance that the investor did not select an enhanced investment rule

5. The system of claim 4 wherein the processing mechanism further includes an optimization mechanism for enhancing a user-specified investment rule to maximize a user-specified objective, given user-specified constraints.

6. The system of claim 3 wherein the processing mechanism further includes a historical evaluation mechanism for evaluating investment rules against historical data to identify an enhanced investment rule.

7. The system of claim 3 wherein the processing mechanism further includes a predictive evaluation mechanism for evaluating investment rules against predictive data to identify an enhanced investment rule, using at least one of: (i) Monte Carlo analysis, (ii) stochaistic analysis, or (iii) other statistical forecasting methods.

8. The system of claim 5 wherein the user-specified objective includes at least one of: (i) highest absolute return; (ii) excess returns over investing in a benchmark; (iii) highest risk-adjusted return; (iv) lowest turnover; (v) least drawdown; (vi) maximum number of consecutive months of positive return; (vii) minimum number of consecutive months of negative return; (viii) high average return when positive; (ix) low average return when negative; and (x) a substantially high ratio of good risk to bad risk.

9. A computer-based method for evaluating a plurality of investment rules, the method including the steps of:
(a) storing financial data associating each of a plurality of asset identifiers with a corresponding asset category; the financial data including historical data specifying past performance for each of a plurality of assets;
(b) evaluating a plurality of investment rules to generate an investment rule evaluation, each investment rule specifying at least one of: (i) a combination of asset identifiers, (ii) a combination of asset categories, (iii) a combination of asset identifier weighing factors specifying a relative proportion of a first asset to a second asset, and (iv) a combination of asset category weighing factors specifying a relative proportion of a first asset category to a second asset category; and
(c) displaying information related to the generated investment rule evaluation.

10. The method of claim 9 further including the steps of accepting a user's selection of at least one investment rule, and responding to the selected investment rule by including an evaluation of the selected investment rule in the generated investment rule evaluation.

11. The method of claim 10 further including the step of accepting a user's selection of at least one of: (i) an investment objective, (ii) an investment constraint, (iii) a time horizon specifying a time duration for which the investment rule is evaluated, (iii) signal data indicative of a trading condition, and (iv) rule criteria that specifies a trading action (quantity/frequency) based upon the signal data.

12. The method of claim 11 further comprising the step of analyzing a plurality of investment possibilities at least roughly approximating the investment rule being evaluated, using an iterative procedure to facilitate an identification of an enhanced or substantially optimized rule, thereby permitting an investor to evaluate investment rules in a range of possible outcomes, and thereby minimizing the chance that the investor did not select an enhanced investment rule.

13. The method of claim 12 further including the step of enhancing a user-specified investment rule to maximize a user-specified objective, given user-specified constraints.

14. The method of claim 13 further including the step of performing a historical evaluation that comparatively evaluates a plurality of investment rules against historical data so as to identify an enhanced investment rule from the plurality of investment rules.

15. The method of claim 13 further including the step of performing a predictive evaluation that comparatively evaluates a plurality of investment rules against predictive data to identify an enhanced investment rule from the plurality of investment rules, using at least one of: (i) Monte Carlo analysis, (ii) stochaistic analysis, or (iii) other statistical forecasting methods.

16. The method of claim 13 wherein the user-specified objective includes at least one of: (i) highest absolute return; (ii) excess returns over investing in a benchmark; (iii) highest risk-adjusted return; and (iv) lowest turnover; (v) least drawdown; (vi) maximum number of consecutive months of positive return; (vii) minimum number of consecutive months of negative return; (viii) high average return when positive; (ix) low average return when negative; (x) substantially high ratio of good risk to bad risk.

17. The method of claim 9 further comprising the step of evaluating an investment rule within the context of a user-specified investment portfolio.

18. The method of claim 17 further comprising the steps of:
storing the financial data in a computer-readable data storage drive accessible by a computer;
linking the computer to at least one user terminal through a data communication link; and,
displaying, at said user terminal, information related to the creation of an investment rule.

19. The method of claim 18 wherein the step of storing writes said financial data into at least one of: (i) a random access memory, (ii) a magnetic storage device, and (iii) an optical storage device.

20. The method of claim 17 wherein the financial data includes at least one of: (i) economic (both macro and micro economic) data, (ii) financial (return, yield, pricing and statistical) data, (iii) portfolio-related data corresponding to a specific user, and (iv) data developed by a specific user to evaluate financial market direction and to signal investment actions

21. The method of claim 20 further including the step of allowing a user to perform mathematical and/or statistical modifications on the financial data to generate a set of user-specific financial data.

22. The method of claim 9 wherein the step of storing further includes storing user-specific information for each of a plurality of users, the user-specific information defining a user's portfolio by specifying (i) the user's allocation to each of a plurality of different asset classes, (ii) at least one benchmark asset to be applied against each of a plurality of asset classes, and (iv) at least one of: a portfolio level constraint specifying allowed leverage, a risk budget, maximum and minimum allowed holdings for various asset classes and benchmark assets, a base currency, allowable frequency of decision making and trading portfolio/investments, and one or more investment objectives against which performance is measured.

23. The method of claim 9 wherein the step of storing further includes storing information related to a plurality of investment rules specified by a user and various aspects of the investment rules, including a time period for evaluation, a data series used to generate the investment rule, including any modifications to market data, constraints, and/or benchmarks.

24. The method of claim 9 wherein the step of storing includes further includes storing the investment rule evaluation as a report, thereby assisting a user in evaluating performance of a plurality of investment rules.

25. The method of claim 9 further including the step of a user accessing the investment rule evaluation over the Internet or an intranet.

26. The method of claim 17 further including the step of displaying the portfolio corresponding to a specified user, wherein the portfolio sets forth: (a) an allocation to each of a plurality of asset classes, (b) one or more investment rules used within each of the asset classes, (c) one or more constraints imposed on the portfolio as a whole or any part thereof, including at least one of leverage, size of an individual asset, risk limit, and trading quantity.

27. The method of claim 26 wherein the step of displaying further includes displaying an entire data set available to a user, as well as a plurality of user-selected modifications that can be made to this data to enhance its predictive capability.

28. The method of claim 27, wherein the step of displaying further includes displaying investment rules at each of a plurality of levels in the portfolio, and displaying a consolidation of a plurality of investment rules in the portfolio, thereby facilitating a user's decision making at a consolidated level as well as at a micro level within the portfolio.

29. The method of claim 28 wherein the step of displaying further includes displaying notification to users monitoring their portfolio and the ongoing status of their active investment rules, and further including the step of updating the financial data using a communication mechanism including at least one of a live trade blotter accessible through an Internet account, a telephone modem, and email.

30. The method of claim 28 wherein the step of displaying further includes the step of generating a set of reports, either in a standard format or custom designed by the user, that report on a plurality of performance measures to evaluate a plurality of investment rules and the portfolio.

31. The method of claim 30 wherein the step of displaying further includes the step of permitting a user to read and print the set of reports.

32. The method of claim 31 further comprising the step of receiving a command, over said communication link, from a user of said user terminal.

33. The method of claim 31 further including the step of receiving a command for accessing specified data from the financial database.

34. The method of claim 31 further including the step of receiving a command for specifying an investment rule and for defining a time period over which the investment rule will be tested.

35. The method of claim 34 further comprising the step of receiving a command specifying one or more investment rules selected in a portfolio or an asset class within a portfolio.

36. The method of claim 35 further comprising the step of receiving a command that defines at least one of: (a) a structure for the portfolio, (b) at least one investment objective, (c) a portfolio level constraint, (d) an investment rule benchmark, and (iv) an asset or asset category allocation.
